(19) United States
(12) Patent Application Publication
(10) Pub. No.: US 2018/0083658 A1
(43) Pub. Date: Mar. 22, 2018

(54) MULTIPLEXING AN RF SIGNAL WITH A CONTROL SIGNAL AND/OR A FEEDBACK SIGNAL

(71) Applicant: QUALCOMM Incorporated, San Diego, CA (US)

(72) Inventors: Eran DOR, Sunnyvale, CA (US); Moshe MEIR, Sunnyvale, CA (US); Eyal HOCHDORF, Palo Alto, CA (US)

(21) Appl. No.: 15/272,829

(22) Filed: Sep. 22, 2016

(51) Int. Cl. H04B 1/04; H04B 1/40; H01Q 1/24

(52) U.S. Cl. CPC H04B 1/0475; H04B 2001/0408; H01Q 1/243; H04B 1/40

(57) ABSTRACT

A communication device includes: a transmission line; a first circuit communicatively coupled to the transmission line and configured to receive an outbound signal over the transmission line, the first circuit comprising an amplifier configured to amplify the outbound signal to form an amplified signal, the first circuit being configured to transmit a first portion of the amplified signal to an antenna element; and a second circuit communicatively coupled to the transmission line and configured to produce the outbound signal and to transmit the outbound signal over the transmission line, the second circuit further being at least one of configured to transmit a control signal for the amplifier over the transmission line or configured to receive a feedback signal, based on the amplified signal, over the transmission line such that the outbound signal and at least one of the control signal or the feedback signal concurrently share the transmission line.

### BACKGROUND

Wireless communications systems are increasingly popular. For example, cellular communications and Wi-Fi communications systems continue to increase in popularity. With increased use has come an increased demand for higher-quality performance of these systems and an increased demand for smaller devices to make up the systems. One technique for improving performance that has become popular is digital pre-distortion of outbound communication signals. For digital pre-distortion, an outbound signal that has been amplified by a power amplifier is fed back to a signal generator. The feedback signal is used to determine the distortion introduced by the power amplifier. The determined distortion is used to determine pre-distortion that is then introduced to future outbound signals so that the distortion introduced by the power amplifier is counteracted by the pre-distortion such that the signal produced by the power amplifier has lower distortion (and better linearity) than without the pre-distortion. The feedback signal used to determine the pre-distortion is provided to the signal generator using a radio-frequency (RF) cable, as is the outbound signal. With numerous, e.g., 12-16, signaling chains (paths from the signal generator to an antenna, and/or from the antenna to a signal receiver) becoming more desirable, the expense and complexity of signal routing in signaling systems is increasing.

### SUMMARY

An example of a communication device includes: a transmission line; a first circuit communicatively coupled to the transmission line and configured to receive an outbound radio-frequency communication signal over the transmission line, the first circuit comprising an amplifier configured to amplify the outbound radio-frequency signal to form an amplified radio-frequency communication signal, the first circuit being configured to transmit a first portion of the amplified radio-frequency communication signal to an antenna element; and a second circuit communicatively coupled to the transmission line and configured to produce the outbound radio-frequency communication signal and to transmit the outbound radio-frequency communication signal over the transmission line, the second circuit further being at least one of configured to transmit a control signal for the amplifier over the transmission line or configured to receive a feedback signal, based on the amplified radio-frequency communication signal, over the transmission line such that the outbound radio-frequency communication signal and at least one of the control signal or the feedback signal concurrently share the transmission line.

Implementations of such a communication device may include one or more of the following features. The second circuit is configured to send the outbound radio-frequency communication signal and the control signal via the transmission line concurrently, and the second circuit is configured to produce the control signal with at least one part, with each of the at least one part having a frequency that is different from a frequency of any other part of the control signal and different from a frequency of the outbound radio-frequency communication signal. The amplifier is a power amplifier and the first circuit includes a low-noise amplifier, the first circuit being configured to respond to a first value of the control signal by enabling the low-noise amplifier, and to respond to a second value of the control signal by enabling the power amplifier. The first circuit is configured to respond to the second value of the control signal by setting an operational mode of the power amplifier.

Also or alternatively, implementations of such a communication device may include one or more of the following features. The first circuit is configured to send a second portion of the amplified radio-frequency communication signal over the transmission line as the feedback signal, and the second circuit and the first circuit are configured, respectively, to send the outbound radio-frequency communication signal and the feedback signal via the transmission line concurrently. The first circuit is configured to frequency modulate the second portion of the amplified radio-frequency communication signal to produce the feedback signal such that a frequency of the feedback signal is different from a frequency of the outbound radio-frequency communication signal. The first circuit is configured to frequency modulate the second portion of the amplified radio-frequency communication signal by mixing the second portion of the amplified radio-frequency communication signal with the control signal.

Also or alternatively, implementations of such a communication device may include one or more of the following features. The first circuit is configured to produce and send the feedback signal over the transmission line and the second circuit is configured to use the feedback signal to adjust a setting affecting linearity of the amplifier. The first circuit comprises an active antenna including the amplifier and the antenna element, and the second circuit comprises a signal processor. The active antenna includes a low-noise amplifier communicatively coupled to the antenna element and configured to amplify an inbound communication signal received by the antenna element, and the amplifier is a power amplifier communicatively coupled to the antenna element and configured to transmit the first portion of the outbound radio-frequency communication signal to the antenna element. The amplifier is a power amplifier and the second circuit includes a transceiver.

An example of a communication method includes: producing an outbound radio-frequency communication signal in a second circuit of a communication device; sending the outbound radio-frequency communication signal from the second circuit to an amplifier of a first circuit of the communication device via a transmission line; amplifying the outbound radio-frequency communication signal in the amplifier to produce an amplified signal; sending a first portion of the amplified signal to an antenna element of the communication device; and at least one of: producing and sending a control signal to the first circuit via the transmission line; or sending a second portion of the amplified signal as a feedback signal to the second circuit via the transmission line; such that the outbound radio-frequency communication signal shares the transmission line concurrently with at least one of the control signal or the feedback signal.

Implementations of such a method may include one or more of the following features. The outbound radio-frequency communication signal and the control signal are sent such that the outbound radio-frequency communication signal and the control signal share the transmission line concurrently, and producing the control signal includes producing the control signal with at least one part, with each of the at least one part having a frequency that is different from a frequency of any other part of the control signal and different from a frequency of the outbound radio-frequency communication signal. The method further includes: in response to a first value of the control signal, enabling a low-noise amplifier of the first circuit; and in response to a second value of the control signal, enabling a power amplifier of the first circuit. The method further includes, in response to the second value of the control signal, setting an operational mode of the power amplifier.

Also or alternatively, implementations of such a method may include one or more of the following features. The outbound radio-frequency communication signal and the feedback signal are sent such that the outbound radio-frequency communication signal and the feedback signal share the transmission line concurrently, the method further comprising frequency modulating the second portion of the amplified signal to produce the feedback signal such that a frequency of the feedback signal is different from a frequency of the outbound radio-frequency communication signal. Frequency modulating the second portion of the amplified signal includes mixing the second portion of the amplified signal with the control signal. The method further includes providing digital pre-distortion using the feedback signal to produce the outbound radio-frequency communication signal to help linearize an output of the amplifier.

Another example of a communication device includes: at least one transmission line; first means, communicatively coupled to the at least one transmission line, for: receiving an outbound radio-frequency communication signal and a control signal; amplifying the outbound radio-frequency communication signal to produce an amplified signal; sending a first portion of the amplified signal to an antenna element; and sending a second portion of the amplified signal as a feedback signal to the at least one transmission line; and second means, communicatively coupled to the at least one transmission line, for producing and sending the outbound radio-frequency communication signal and the control signal to the at least one transmission line and for receiving the feedback signal from the at least one transmission line; where the first means and the second means are for, respectively, sending and receiving, via the at least one transmission line, the outbound radio-frequency communication signal and at least one of the control signal or the feedback signal concurrently over a single transmission line of the at least one transmission line.

Implementations of such a communication device may include one or more of the following features. The second means are for sending the outbound radio-frequency communication signal and the control signal via the single transmission line concurrently, and the second means are for producing the control signal with at least one part, with each of the at least one part having a frequency that is different from a frequency of any other part of the control signal and different from a frequency of the outbound radio-frequency communication signal. The first means include a low-noise amplifier and a power amplifier, and the first means are for responding to a first value of the control signal by enabling the low-noise amplifier, and for responding to a second value of the control signal by enabling the power amplifier. The first means are for responding to the second value of the control signal by setting an operational mode of the power amplifier.

Also or alternatively, implementations of such a communication device may include one or more of the following features. The second means and the first means are for, respectively, sending the outbound radio-frequency communication signal and the feedback signal via the single transmission line concurrently, and the first means are for frequency modulating the second portion of the amplified signal to produce the feedback signal such that a frequency of the feedback signal is different from a frequency of the outbound radio-frequency communication signal. The first means are for frequency modulating the second portion of the amplified signal by mixing the second portion of the amplified signal with the control signal. The second means are for producing the outbound radio-frequency communication signal using the feedback signal to provide digital pre-distortion.

An example of a power amplifier system includes: an input coupled to a transmission line; an output coupled to an antenna element; amplifying means for amplifying a radio frequency signal received over the transmission line; and control means for controlling the amplifying means based on a control signal received over the transmission line concurrently with the radio frequency signal.

Implementations of such a communication device may include means for transmitting a feedback signal over the transmission line.

### BRIEF DESCRIPTION OF THE DRAWINGS

FIG. 1 is a schematic diagram of a communication system.

FIG. 2 is a block diagram of components of a communication device, here an access point, shown in FIG. 1.

FIG. 3 is a block diagram of components of a signal processor shown in FIG. 2.

FIG. 4 is a block diagram of components of an active antenna shown in FIG. 2.

FIG. 5 is a block diagram of components of an alternative communication device.

FIG. 6 is a block flow diagram of a communication method.

### DETAILED DESCRIPTION

Techniques are discussed herein for multiplexing a radio-frequency communication signal over a transmission line connected to an active antenna with a control signal sent to the active antenna and/or a feedback signal sent from the active antenna. Thus, the radio-frequency communication signal may be transmitted over a transmission line connected to an active antenna and, transmitted concurrently over the same transmission line, the control signal may be sent to the active antenna and/or the feedback signal may be sent from the active antenna. For example, an outbound RF communication signal may be sent over a transmission line from a signal processor to an active antenna. A control signal may be produced to have a frequency that is different from the outbound RF communication signal to help avoid the control signal interfering with the outbound RF communication signal. The control signal is sent over the same transmission line that conveys the outbound RF communication signal and may be sent concurrently with the outbound RF communication signal. A portion of the outbound RF communication signal may be isolated as the feedback signal, e.g., for use in digital pre-distortion determination by the signal processor. The feedback signal has its frequency changed, to be different than the frequency of the outbound RF communication signal, before being conveyed by the transmission line to the signal processor. The feedback signal may be conveyed by the transmission line concurrently with the outbound RF communication signal. Further, an inbound RF communication signal may be received by the active antenna and conveyed by the transmission line to the signal processor concurrently with the control signal. These examples, however, are not exhaustive.

Items and/or techniques described herein may provide one or more of the following capabilities, as well as other capabilities not mentioned. Active antennas may be used that facilitate thermal management in a signaling system. Noise figure performance, sensitivity, and/or range over rate may be improved in signaling systems. Energy losses may be reduced, transmission power increased, and/or current reduced in signaling systems. Using an active antenna facilitates having a short distance from the antenna to a low-noise amplifier that helps provide better noise figure performance, better sensitivity, and improved range over rate. Having a short distance from a power amplifier to the antenna provides low loss between the power amplifier and the antenna, enabling transmission power closer to regulatory limitations. As regulatory limitations may be constant, for low data rates a current saving may be realized because the power amplifier may use less power than in traditional systems. Further, as the power amplifier typically produces significant heat, having the power amplifier in the active antenna instead of in a main enclosure facilitates heat management. For example, if a device has 12-16 signal chains, then about 24-32 W out of about 65 W of power may be disposed in active antennas instead of the main enclosure, that houses a processor and other components of a device (e.g., an access point), making thermal management easier. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

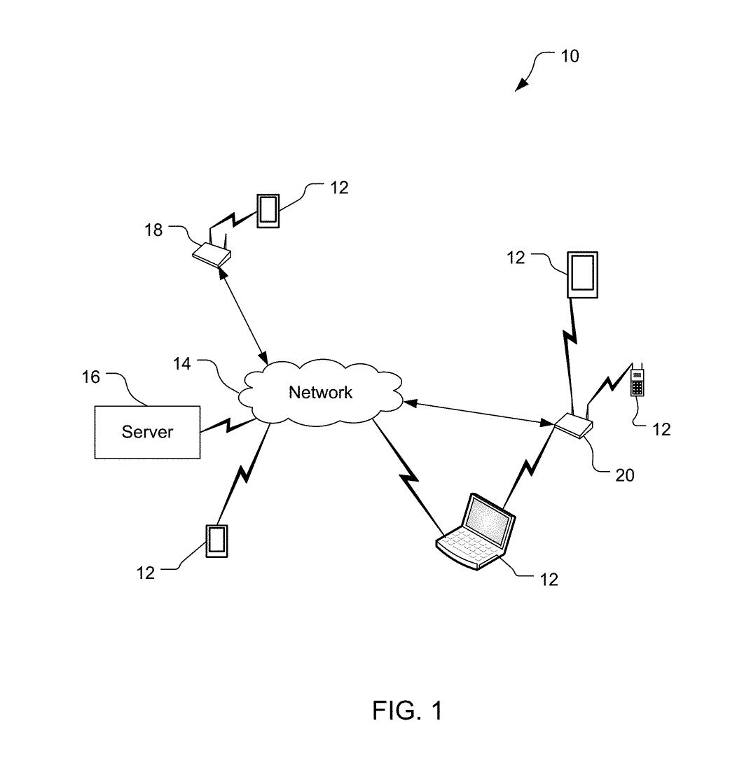

Referring to FIG. 1, a communication system 10 includes mobile devices 12, a network 14, a server 16, and access points (APs) 18, 20. The system 10 is a communication system in that components of the system 10 can communicate with one another directly or indirectly, e.g., via the network 14 and/or one or more of the access points 18, 20 (and/or one or more other devices not shown, such as one or more base transceiver stations). For indirect communications, the communications may be altered during transmission from one entity to another, e.g., to alter header information of data packets, to change format, etc. The example mobile devices 12 shown include mobile phones (including smartphones), a laptop computer, and a tablet computer. Still other mobile devices may be used, whether currently existing or developed in the future.

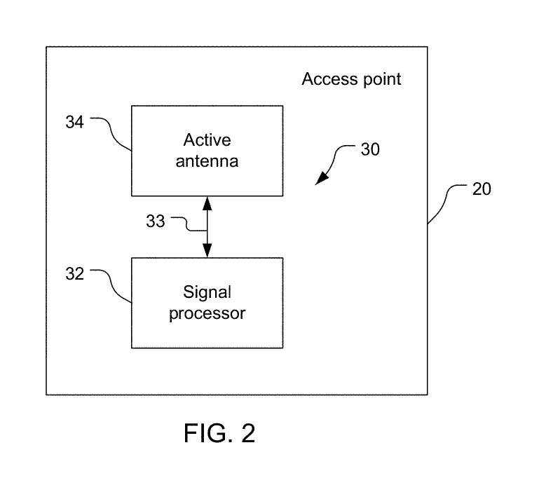

Referring also to FIG. 2, an example of the access point 20 includes a signaling system 30 that includes a signal processor 32 (included in signal processing means) and an active antenna 34 (included in active antenna means). The active antenna 34 is an active antenna in that the active antenna 34 includes an antenna element (for radiating and receiving signals) and at least one amplifier. Although only one active antenna 34 is shown in FIG. 2, the system 30 may include more than one active antenna and/or more than one signal processor, and a single housing may contain more than one active antenna. The active antenna 34 is communicatively coupled to the signal processor 32 by a transmission line 33 to form a signal chain. While only one signal chain is shown in FIG. 2, multiple signal chains may be used, for example with multiple active antennas served by one or more respective signal processors. Multiple signal chains may be used, for example, to communicate in different networks and/or for different purposes (e.g., Wi-Fi communication, multiple frequencies of Wi-Fi communication, satellite positioning, etc.). In accordance with the disclosure, preferably the transmission line 33 conveys a radio-frequency (RF) signal concurrently with a control signal and/or an RF feedback signal, e.g., for pre-distortion determination. The RF signal and the control signal and/or the RF feedback signal are concurrently conveyed by the transmission line 33 in that at least respective portions of the concurrently-conveyed signals overlap in time while being conveyed by the transmission line 33. While the signaling system 30 is discussed as being part of the access point 20, the signaling system 30 could be part of another device, either another access point or a device other than an access point.

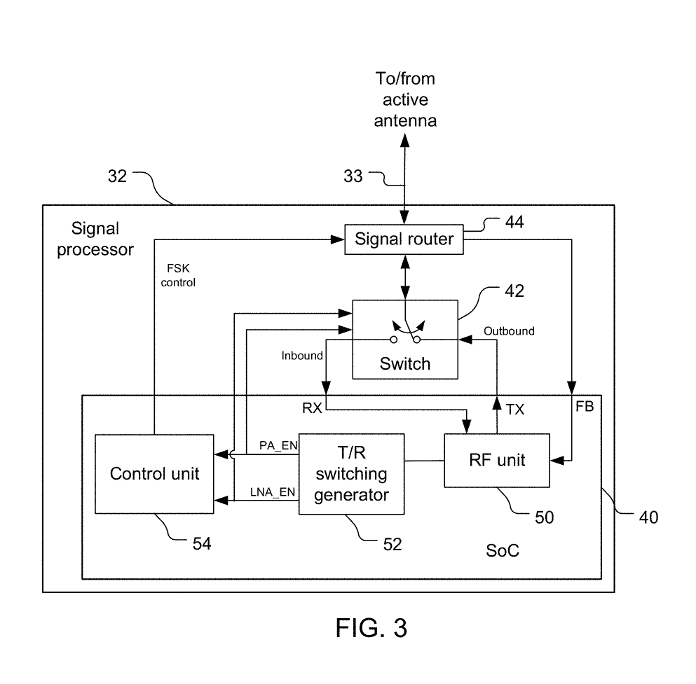

Referring also to FIG. 3, the signal processor 32 includes a System on a Chip (SoC) 40, a switch 42, and a signal router 44. The signal processor 32, in particular the SoC 40, is configured to produce an outbound radio-frequency communication signal and a control signal and send these signals to the active antenna 34 via the switch 42, the signal router 44, and the transmission line 33. The signal processor 32, in particular the SoC 40, is further configured to receive an inbound RF communication signal from the active antenna 34 via the transmission line 33, the signal router 44, and the switch 42 and process the inbound RF communication signal appropriately.

The SoC 40 includes an RF unit 50, a transmit/receive (T/R) switching generator 52, and a control unit 54 (included in control means). The RF unit 50 (included in radio-frequency means) is configured to generate outbound RF communication signals, e.g., Wi-Fi communication signals, for use in wireless communications, e.g., with one or more of the mobile devices 12. The RF unit 50 is configured to introduce pre-distortion to produce the outbound RF communication signals based on a feedback signal received from the active antenna 34 (as further discussed below). The RF unit 50 is further configured to receive inbound RF communication signals and process the signals appropriately to interpret the communications, e.g., from one or more of the mobile devices 12. The RF unit 50 is configured to send the outbound communication signals through a transmit port TX to the switch 42 and to receive the inbound RF communication signals from a receive port RX from the switch 42. The RF unit 50 is communicatively coupled to the T/R switching generator 52. While the signal processor 32, and in particular the SoC 40, is shown including both the control unit 54, configured to produce and provide the control signal, and the RF unit 50, configured to receive the feedback signal and to produce and provide the outbound communication signals, other implementations may include only one of a control unit or an RF unit.

The T/R switching generator 52 is configured to produce appropriate control signals to ensure proper routing of the outbound RF communication signals and the inbound RF communication signals by the switch 42, and proper processing of RF signals by the active antenna 34. The T/R switching generator 52 monitors the outbound RF communication signals produced by the RF unit 50 and produces one or more control signals, here a power amplifier enable (PA_EN) signal and a low-noise amplifier enable (LNA_EN) signal, with appropriate timing relative to the outbound RF communication signals produced by the RF unit 50. The PA_EN signal and the LNA_EN signal are configured to indicate, respectively, to enable a power amplifier of the active antenna 34 and a low-noise amplifier of the active antenna 34, although only one of the LNA_EN signal or the PA_EN signal may be produced and provided by the T/R switching generator 52 at any given time. For example, a high voltage level of the PA_EN signal or a high voltage level of the LNA_EN signal may indicate to enable the power amplifier or the low-noise amplifier, respectively. The high voltage level of the PA_EN signal is preferably different from the high voltage level of the LNA_EN signal such that, as discussed below, the control unit 54 will produce a control signal with different frequencies based on the two high voltage levels. The PA_EN signal and/or the LNA_EN signal may also or alternatively indicate an operational mode of the power amplifier and/or the low-noise amplifier, respectively, e.g., based on a voltage level, from multiple voltage levels, to which the respective signal is set. For example, there may be multiple levels of amplification for the LNA 64 and/or the PA 68 such that the LNA 64 and/or the PA 68 could amplify by different amounts in different operational modes, with the LNA_EN signal and/or the PA_EN signal having multiple corresponding values. The T/R switching generator 52 is communicatively coupled to the switch 42 and to the control unit 54 to provide the PA_EN signal and the LNA_EN signal to both the switch 42 and the control unit 54.

The switch 42 is configured to route the outbound RF communication signals from the SoC 40 to the signal router 44, or to route the inbound RF communication signals from the signal router 44 to the SoC 40, based on the control signal(s) from the T/R switching generator 52. The switch 42 is communicatively coupled to the signal router 44, to the receive port RX of the SoC 40, and to the transmit port TX of the SoC 40. The switch 42 is configured to respond to the control signal(s), in this example the PA_EN signal and/or the LNA_EN signal, from the T/R switching generator 52 to couple the signal router 44 to the transmit port TX of the SoC 40 or to the receive port RX of the SoC 40. That is, based on the PA_EN signal and/or the LNA_EN signal, the switch 42 will direct outbound RF communication signals from the transmit port TX of the SoC 40 to the signal router 44 or direct inbound RF communication signals from the signal router 44 to the receive port RX of the SoC 40. For example, the switch 42 may be configured to respond to the PA_EN signal indicating to enable a power amplifier of the active antenna 34 by connecting the transmit port TX of the SoC 40 with the signal router 44. Further, the switch 42 may be configured to respond to the LNA_EN signal indicating to enable the low-noise amplifier of the active antenna 34 by connecting the receive port RX of the SoC 40 with the signal router 44. Alternatively, the switch 42 may be configured to respond to the PA_EN signal indicating to enable the power amplifier and the LNA_EN signal indicating to disable the low-noise amplifier (e.g., by being absent or a specific disable-value voltage) by connecting the transmit port TX to the signal router 44, and to respond to the LNA_EN signal indicating to enable the low-noise amplifier and to the PA_EN signal indicating to disable the power amplifier (e.g., by being absent or a specific disable-value voltage) by connecting the receive port RX with the signal router 44.

The control unit 54 is configured to produce a control signal based on the control signal(s) from the T/R switching generator 52, in this example the PA_EN signal and the LNA_EN signal. The control unit 54 is preferably configured to produce the control signal such that the control signal may be conveyed via the transmission line 33 concurrently with the outbound RF communication signal or the inbound RF communication signal or a feedback signal without significantly affecting the respective communication signal or feedback signal. That is, the control signal preferably will not alter the communication signal so much that the interpretation of the communication signal will be changed by the presence of the control signal on the transmission line 33 concurrently with the respective communication signal. Further, the control signal preferably will not alter the feedback signal more than a threshold amount, e.g., corresponding to a threshold amount of error in digital pre-distortion determined based on the feedback signal. The control unit 54 is further configured to provide the FSK control signal to the signal router 44 for transmission to the active antenna 34 via the signal router 44 and the transmission line 33.

The control unit 54, for example, is preferably configured to produce the control signal as a frequency-shift-keyed (FSK) control signal whose frequency is based on a value of the PA_EN signal and/or the LNA_EN signal from the T/R switching generator 52. In this case, the control unit 54 is an FSK modulator that uses the PA_EN signal and the LNA_EN signal as inputs to produce the FSK control signal output. As an FSK modulator, the control unit 54 produces a signal with a frequency that is dependent upon a voltage level of an input. In this case, the control unit 54 is configured to produce the FSK control signal with one frequency based on one voltage level and to produce the FSK control signal with a different frequency based on another voltage level, thus being configured to produce two frequencies based on two voltage levels, with both of the frequencies being different from the frequency of the outbound RF communication signal, the inbound RF communication signal, and the feedback signal (discussed more fully below). Alternatively, the control unit 54 may produce more frequencies, e.g., to indicate more complex control such as to indicate an operational mode of the power amplifier and/or the low-noise amplifier. The control unit 54 is preferably configured to transmit the FSK control signal to indicate either the PA_EN signal or the LNA_EN signal at any given time.

The control unit 54 is preferably configured to disable either the power amplifier or the low-noise amplifier of the active antenna 34 before transmitting the FSK control signal to indicate to enable the other of the power amplifier or the low-noise amplifier of the active antenna 34. That is, there will preferably be an off state or mode between the PA 68 being enabled and the LNA 64 being enabled, or vice versa. The FSK control signal may indicate to disable the power amplifier by the absence from the FSK control signal of an indication to enable the power amplifier. Similarly, the FSK control signal may indicate to disable the low-noise amplifier by the absence from the FSK control signal of an indication to enable the low-noise amplifier. Alternatively, the control unit 54 may be configured to produce other frequencies for the FSK control signal to indicate to disable the power amplifier and/or the low-noise amplifier.

The signal router 44 is configured to convey (direct) the outbound RF communication signals, the inbound RF communication signals, the FSK control signal, a feedback signal (as discussed below), and a DC signal (not shown) appropriately. The signal router 44 is communicatively coupled to the transmission line 33, the switch 42, and the control unit 54 of the SoC 40. The signal router 44, e.g., a triplexer, may be a band-pass filter configured to convey signals as desired as discussed herein to allow signals to pass to a desired connection and block them from passing to undesired connections. The signal router 44 is configured to pass the outbound RF communication signal received from the switch 42 to the transmission line 33, to pass the inbound RF communication signals received from the transmission line 33 to the switch 42, and to pass the FSK control signal received from the control unit 54 to the transmission line 33. Further, the signal router 44 is configured to pass a DC signal (not shown) from a power source (not shown) to the transmission line 33.

The transmission line 33 is coupled to the signal processor 32 and the active antenna 34 and is configured to convey the outbound RF communication signals, the inbound RF communication signals, the FSK control signal, a feedback signal, and DC power. For example, the transmission line 33 may be a coaxial cable. The transmission line 33 is configured to convey RF signals, the FSK control signal, and DC power concurrently. Thus, a single transmission line may concurrently convey an RF communication signal and the FSK control signal and/or the feedback signal.

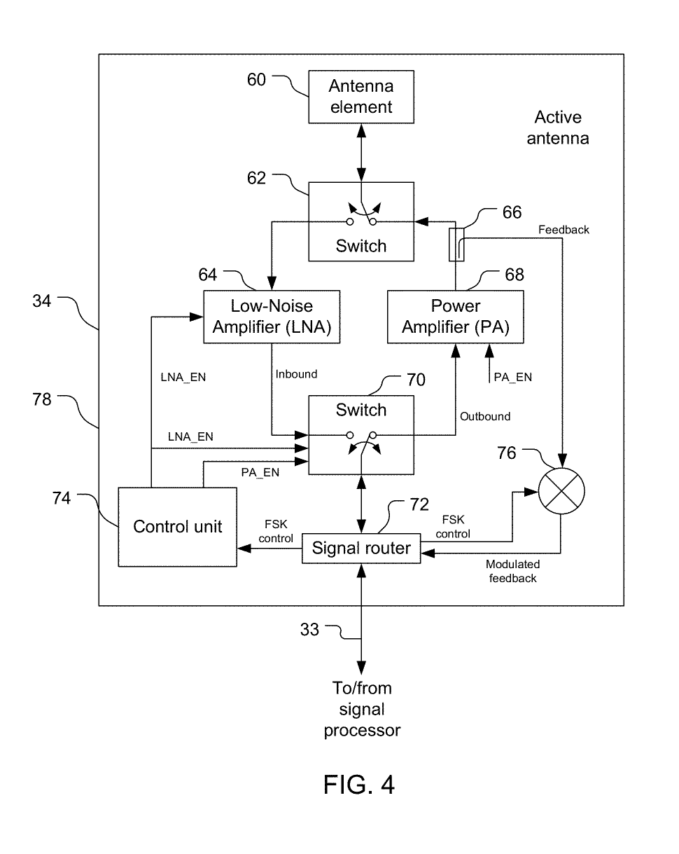

Referring to FIG. 4, with further reference to FIGS. 1-3, the active antenna 34 has an antenna element 60, an antenna-interface switch 62, a low-noise amplifier (LNA) 64, a coupler 66, a power amplifier (PA) 68, a signal-router-interface switch 70, a signal router 72, a control unit 74 (included in control means), and a frequency modulator 76 (included in frequency-modulation means), here a mixer. Preferably all of the components of the active antenna 34 shown, but at least the antenna element 60, the antenna-interface switch 62, the LNA 64, and the PA 68, are integrated into a single unit disposed in a single housing 78. The active antenna 34 is configured to receive outbound RF communication signals from the signal processor 32, amplify these signals in the PA 68, provide the amplified signals to the antenna element 60 via the switch 62, and wirelessly transmit the amplified signals via the antenna element 60. Further, the active antenna 34 is configured to receive inbound RF communication signals wirelessly via the antenna 60, provide these signals via the switch 62 to the LNA 64 that amplifies these signals, and provide the amplified inbound signals to the signal processor 32. The transmission line 33 is coupled to the signal router 72 to convey inbound RF communication signals received from the signal router 72 to the signal processor 32 and to provide outbound RF communication signals received from the signal processor 32 to the signal router 72.

The signal router 72 is configured to convey (direct) the outbound RF communication signals, the inbound RF communication signals, the FSK control signal, the feedback signal (as discussed more fully below), and the DC signal appropriately. The signal router 72 is communicatively coupled to transmission line 33, the switch 70, and the control unit 74. The signal router 72, e.g., a triplexer, may be a band-pass filter configured to convey signals as desired as discussed herein to allow signals to pass to a desired connection and block them from passing to undesired connections. The signal router 72 is configured to pass the outbound RF communication signal received from the transmission line 33 to the switch 70, to pass the inbound RF communication signal received from switch 70 to the transmission line 33, and to pass the FSK control signal received from the transmission line 33 to the control unit 74 and to the frequency modulator 76. Further, the signal router 72 is configured to pass the DC signal (not shown) from the transmission line 33 to a front-end module (FEM) containing the LNA 64 and the PA 68.

The control unit 74 is configured interpret the control signal received from the signal router 72 to reproduce the control signal(s) produced by the T/R switching generator 52. Here, the control unit 74 is an FSK demodulator configured to demodulate the FSK control signal to reproduce the PA_EN signal and/or the LNA_EN signal. For example, the control unit 74 may demodulate the frequency of the FSK control signal to determine values that the control unit 74 converts (e.g., by comparing to known values) into voltage signals as the PA_EN signal and/or the LNA_EN signal. The control unit 74 is configured to provide the PA_EN signal to the PA 68, to provide the LNA_EN signal to the LNA 64, and to provide the PA_EN signal and the LNA_EN signal to the switch 70, although only one of the LNA_EN signal or the PA_EN signal may be produced and provided at any given time.

The switch 70 is configured to route the outbound RF communication signals from the signal router 72 to the PA 68, and to route the inbound RF communication signals from LNA 64 to the signal router 72, based on the PA_EN signal and/or the LNA_EN signal from the control unit 74. The switch 70 is communicatively coupled to the signal router 72, to the LNA 64, and to the PA 68. The switch 70 is configured to respond to the control signal(s), in this example the PA_EN signal and/or the LNA_EN signal, from the control unit 74 to couple the signal router 72 to the LNA 64 or to the PA 68. That is, based on the PA_EN signal and/or the LNA_EN signal, the switch 70 will direct outbound RF communication signals from the signal router 72 to the PA 68 or direct inbound RF communication signals from LNA 64 to the signal router 72. For example, the switch 70 may be configured to respond to the PA_EN signal indicating to enable the PA 68 by connecting the signal router 72 to the PA 68. Further, the switch 70 may be configured to respond to the LNA_EN signal indicating to enable the LNA 64 by connecting the signal router 72 to the LNA 64. Alternatively, the switch 70 may be configured to respond to the PA_EN signal indicating to enable the PA 68 and the LNA_EN signal indicating to disable the LNA 64 (e.g., by being absent or a specific disable-value voltage) by connecting the signal router 72 to the PA 68, and to respond to the LNA_EN signal indicating to enable the LNA 64 and to the PA_EN signal indicating to disable the PA 68 (e.g., by being absent or a specific disable-value voltage) by connecting the signal router 72 to the LNA 64.

The LNA 64 is configured to receive inbound RF communication signals from the switch 62 and to amplify the received inbound RF communication signals. The LNA 64 is configured to receive an inbound RF communication signal from the switch 62, to amplify this received signal to produce an amplified inbound signal, and to convey (provide or send) the amplified inbound signal to the switch 70. The LNA 64 is configured to amplify the inbound RF communication signal while the LNA 64 is enabled. The LNA 64 is configured to respond to the LNA_EN signal indicating to enable (activate) amplification by amplifying the signal received from the switch 62 and providing the amplified signal to the switch 70, and otherwise not to amplify the signal received from the switch 62. The LNA 64 may be configured to respond to the LNA_EN signal by setting an operational mode of the LNA 64.

The PA 68 is configured to receive outbound RF communication signals from the switch 70 and to amplify the received outbound RF communication signals. The PA 68 is configured to receive an outbound RF communication signal from the switch 70, to amplify this received signal to produce an amplified outbound signal, and to convey (provide or send) the amplified outbound signal to the coupler 66. The PA 68 is configured to amplify the outbound RF communication signal while the PA 68 is enabled. The PA 68 and is configured to respond to the PA_EN signal indicating to enable (activate) amplification by amplifying the signal received from the switch 70 and providing the amplified signal to the coupler 66, and otherwise not to amplify the signal received from the switch 70. The PA 68 may be configured to respond to the PA_EN signal by setting an operational mode of the PA 68.

The coupler 66 is communicatively coupled to the power amplifier 68, the switch 62, and the frequency modulator 76 and configured to convey a respective portion of the amplified outbound RF communication signal received from the PA 68 to each of the switch 62 and the frequency modulator 76. The coupler 66 is configured to split the amplified outbound RF communication signal received from the PA 68 into two portions. The coupler 66 is configured to separate and convey a first, major portion of the outbound RF communication signal to the switch 62. For example, the first, major portion of the outbound RF communication signal may contain approximately 90% (or 92%, or 95%, or 97%) of the power of the amplified outbound RF communication signal received from the PA 68. The coupler 66 is further configured to separate and convey a second, minor portion of the amplified outbound RF communication signal to the frequency modulator 76. For example, the second, minor portion of the outbound RF communication signal may contain approximately 10% (or 8%, or 5%, or 3%) of the power of the amplified outbound RF communication signal received from the PA 68. The second, minor portion of the outbound RF communication signal sent to the frequency modulator 76 is a feedback signal.

The switch 62 is configured to route the first output of the coupler to direct the outbound RF communication signals from the coupler 66 to the antenna element 60, and to route the inbound RF communication signals received from the antenna element 60 to the LNA 64, e.g., based on the PA_EN signal and the LNA_EN signal from the control unit 74. The switch 62 is communicatively coupled to the antenna element 60, to the LNA 64, and to the coupler 66. The switch 62 is configured to respond to the control signal(s), in this example the PA_EN signal and/or the LNA_EN signal, from the control unit 74 to couple the antenna element 60 to the LNA 64 or to the coupler 66. That is, based on the PA_EN signal and/or the LNA_EN signal, the switch 62 will direct outbound RF communication signals from the coupler 66 to the antenna element 60 or direct inbound RF communication signals from the antenna element 60 to the LNA 64. For example, the switch 62 may be configured to respond to the PA_EN signal indicating to enable the PA 68 by connecting the coupler 66 to the antenna element 60. Further, the switch 62 may be configured to respond to the LNA_EN signal indicating to enable the LNA 64 by connecting the antenna element 60 to the LNA 64. Alternatively, the switch 62 may be configured to respond to the PA_EN signal indicating to enable the PA 68 and the LNA_EN signal indicating to disable the LNA 64 (e.g., by being absent or a specific disable-value voltage) by connecting the coupler 66 to the antenna element 60, and to respond to the LNA_EN signal indicating to enable the LNA 64 and to the PA_EN signal indicating to disable the PA 68 (e.g., by being absent or a specific disable-value voltage) by connecting the antenna element 60 to the LNA 64.

The frequency modulator 76 is configured to process the second output of the coupler 66 for conveyance by the transmission line 33 to the signal processor 32 to help avoid interference between the feedback signal and the outbound RF communication signal and/or the FSK control signal. The frequency modulator 76 is configured to alter the frequency of the feedback signal to produce a modulated feedback signal. The modulated feedback signal may be referred to herein as simply the feedback signal as the modulated feedback signal contains the second portion of the amplified outbound RF communication signal split out by the coupler 66, but in a different frequency. The frequency modulator 76 may be configured to upconvert the frequency of the feedback signal or to downconvert the frequency of the feedback signal. The frequency modulator 76 is configured to receive the feedback signal from the coupler 66, to produce the modulated feedback signal, and to provide the modulated feedback signal to the signal router 72. The frequency modulator 76 is preferably configured to produce the modulated feedback signal such that the frequency of the modulated feedback signal is different from the frequency of the outbound RF communication signal and the frequency of the FSK control signal. The frequency modulator 76 is preferably configured to produce the modulated feedback signal such that the modulated feedback signal may be conveyed via the transmission line 33 concurrently with the outbound RF communication signal or the FSK control signal without significantly affecting the respective signal. That is, the modulated frequency signal will not alter the RF communication signal so much that the interpretation of the communication signal or the FSK control signal will be changed by the presence of the modulated frequency signal on the transmission line 33 concurrently with the respective communication signal. In the example shown in FIG. 4, the frequency modulator 76 is a mixer configured to frequency modulate the feedback signal from the coupler 66 by mixing the feedback signal with the FSK control signal received from the signal router 72 to produce the modulated feedback signal. Other configurations of the frequency modulator for modulating the feedback signal may, however, be used. Further, the frequency modulator 76 could be integrated in a FEM with the LNA 64 and the PA 68.

The signal router 72 is configured to convey (direct) the modulated feedback signal to the transmission line 33. The signal router 72 is communicatively coupled to the transmission line 33 and to the frequency modulator 76. The signal router 72 is configured to direct the modulated feedback signal, e.g., based on the frequency of the modulated frequency signal, to the transmission line 33 for conveyance to and processing by (discussed below) the signal processor 32.

Referring again to FIG. 3, the signal processor 32 is configured to route and process the feedback signal from the active antenna 34 to determine digital pre-distortion for the outbound RF communication signal. The signal router 44 is communicatively coupled to a feedback port FB of the SoC 40 and is configured to route the feedback signal (i.e., the modulated feedback signal) to the feedback port FB. The RF unit 50 is communicatively coupled to the feedback port FB and configured to receive and process the feedback signal to determine digital pre-distortion (DPD). The RF unit 50 may be configured to determine the DPD during training sessions that may be conducted intermittently (e.g., periodically, during a first outbound transmission after a threshold time without performing DPD, etc.), but preferably not every time that the PA 68 is enabled. The RF unit 50 is configured to use the determined DPD to produce the outbound RF communication signal to help linearize the amplified outbound RF communication signal provided to the antenna element 60, i.e., to compensate for non-linear amplification by the PA 68. Thus, the DPD will help correct non-linear distortion in a transfer function of the PA 68.

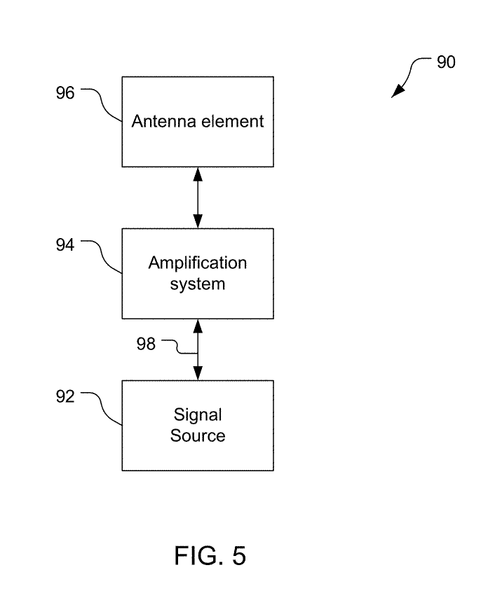

Although FIGS. 2 and 4 discuss that an access point 20 is a communication device according to the disclosure and includes the active antenna 34, other communication devices and configurations of communication devices may be used according to the disclosure. For example, communication devices other than access points may be used and a communication device need not use an active antenna. Referring to FIG. 5, a communication device 90 includes a signal source 92, an amplification system 94, and an antenna element 96. The signal source 92 is communicatively coupled to the amplification system 94 through a transmission line 98. The signal source 92 may be configured similarly to the signal processor 32 discussed above. The signal source 92 may be a transceiver, and may produce communication signals and/or control signals, or may convey, but not produce, one or more of these signals. Further, although only one transmission line is shown in FIG. 5, more than one transmission line may couple the signal source 92 and the amplification system 94, but similar to the discussion above, in certain implementations only one transmission line will concurrently convey an outbound radio-frequency communication signal and a control signal and/or a feedback signal. In some embodiments, a plurality of amplification systems 94 are implemented in a device and a single respective transmission line from the signal source 92 to each amplification system 94 is implemented. The amplification system 94 may be configured similarly to the active antenna 34 discussed above, but may not include the antenna element 60 and/or one or more other elements illustrated with in FIG. 4 such as the LNA. Instead, the communication device 90 may not include an active antenna, with the amplification system 94 not being integrated into a single unit with the antenna element 96. In some embodiments, the amplification system 94 comprises a PA system and/or module.

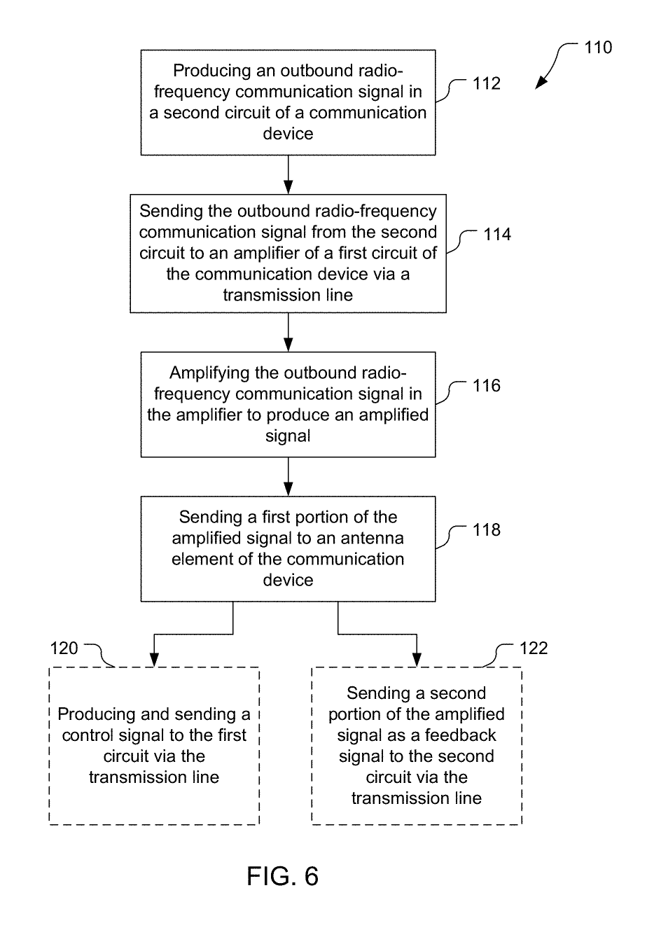

Referring to FIG. 6, with further reference to FIGS. 1-5, a communication method 110 includes the stages shown. The method 110 is, however, an example only and not limiting. The method 110 can be altered, e.g., by having stages added, removed, rearranged, combined, performed concurrently, and/or having single stages split into multiple stages. For illustrative purposes, the stages of the method 110 are discussed below with respect to the access point 20 shown in FIGS. 2-4 and discussed above, but the method 110 is equally applicable to the communication device 90 shown in FIG. 5, or other communication devices in accordance with the disclosure.

At stage 112, the method 110 includes producing an outbound radio-frequency communication signal in a second circuit of a communication device. For example, the RF unit 50 of the signal processor 32 of the access point 20 produces the outbound RF communication signal as appropriate. The outbound signal may, for example, be a request to another device, a response to another device, part of a two-way conversation, a broadcast message, etc.

At stage 114, the method 110 includes sending the outbound radio-frequency communication signal from the second circuit to an amplifier of a first circuit of the communication device via a transmission line. For example, the RF unit 50 sends the outbound RF communication signal to the switch 42. The switch 42 connects the transmit port TX of the SoC 40 to the signal router 44, e.g., in response to the PA_EN signal indicating to enable the PA 68, to direct the outbound RF communication signal from the RF unit 50 to the signal router 44. The signal router 44 conveys the outbound RF communication signal to the transmission line 33 that conveys the outbound RF communication signal to the active antenna 34.

At stage 116, the method 110 includes amplifying the outbound radio-frequency communication signal in the amplifier to produce an amplified signal. For example, the PA 68 amplifies the outbound RF communication signal. The PA 68 may amplify the outbound RF communication signal in response to being activated in accordance with the PA_EN signal indicating to enable the PA 68.

At stage 118, the method 110 includes sending a first portion of the amplified signal to an antenna element of the communication device. For example, the coupler 66 splits the amplified outbound RF communication signal from the PA 68 into the major and minor portions and sends the major portion to the antenna element 60.

At stage 120, the method 110 includes producing and sending a control signal to the first circuit via the transmission line. For example, the control unit 54 produces the FSK signal based on the voltage of the PA_EN signal and/or the voltage of the LNA_EN signal to produce the FSK control signal with a frequency representing the PA_EN signal or the LNA_EN signal at any given time. For example, the control unit 54 may send the FSK control signal continuously, e.g., corresponding to either the PA_EN signal indicating whether to enable the PA 68 or the LNA_EN signal indicating whether to enable the LNA 64. Alternatively, the control unit 54 may intermittently send the FSK control signal, e.g., periodically, or only in response to a change in the PA_EN and LNA_EN signals, e.g., changing from indicating to enable the PA 68 to indicating to enable the LNA 64 or changing from indicating to enable the LNA 64 to indicating to enable the PA 68. The control unit 54 sends the FSK control signal to the signal router 44 that conveys the FSK control signal to the transmission line 33 that conveys the FSK control signal to the active antenna 34.

At stage 122, the method 110 includes sending a second portion of the amplified signal as a feedback signal to the second circuit via the transmission line. For example, the coupler 66 sends the minor portion of the amplified outbound RF communication signal (see discussion of stage 118) to the signal processor 32 via the transmission line 33.

While stages 120 and 122 are shown in dashed lines as being optional, one or both of the stages 120, 122 is(are) performed in the method 110. One or both of the stages 120, 122 is(are) performed such that the outbound radio-frequency communication signal shares a single transmission line concurrently with at least one of the control signal or the feedback signal. For example, the FSK control signal may be concurrently conveyed by the transmission line 33 with the outbound RF communication signal. In this case, the control signal may be produced with at least one part, with each of the at least one part having a frequency that is different from a frequency of any other part of the control signal and different from a frequency of the outbound radio-frequency communication signal. Further, the method 110 may include enabling a low-noise amplifier of the active antenna in response to a first value of the control signal and enabling a power amplifier of the active antenna in response to a second value of the control signal. Further still, the method 110 may include setting an operational mode of the power amplifier in response to the second value of the control signal. Also or alternatively, the feedback signal (e.g., the modulated feedback signal) may be concurrently conveyed by the transmission line 33 with the outbound RF communication signal. In this case, the method 110 may include frequency modulating the second portion of the amplified signal to produce the feedback signal such that a frequency of the feedback signal is different from a frequency of the outbound radio-frequency communication signal. For example, frequency modulating the second portion of the amplified signal may comprise mixing the second portion of the amplified signal with the control signal. Further, the frequency of the feedback signal preferably has a frequency different from the frequency of any part of the control signal. Also or alternatively, the method 110 may comprise providing digital pre-distortion using the feedback signal to produce the outbound radio-frequency communication signal.

### Other Considerations

Outbound RF communication signals and inbound RF communication signals are discussed as being sent and/or received. These signals may be sent or received one at a time, and the devices for doing so may be configured accordingly. For example, the LNA 64 receive and amplify a single inbound RF communication signal at any one time. As another example, the PA 68 may receive and amplify a single output RF communication signal at any one time. Thus, while the plural “signals” is often used when discussing the RF communication signals, this includes the use of the singular “signal” as the use of “singles” may refer to different single RF communication signals over time.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. A communication device comprising:
a transmission line comprising a plurality of conductors;
a first circuit communicatively coupled to the transmission line and configured to receive an outbound radio-frequency communication signal over the transmission line, the first circuit comprising an amplifier configured to amplify the outbound radio-frequency signal to form an amplified radio-frequency communication signal, the first circuit being configured to transmit a first portion of the amplified radio-frequency communication signal to an antenna element; and
a second circuit communicatively coupled to the transmission line and configured to produce the outbound radio-frequency communication signal and to transmit the outbound radio-frequency communication signal over the transmission line, the second circuit further configured to:
transmit a control signal for the amplifier over the transmission line; or
receive a feedback signal, based on a second portion of the amplified radio-frequency communication signal, over the transmission line; or
a combination thereof;
such that the control signal or the feedback signal, or a combination thereof, will be conveyed concurrently with the outbound radio frequency communication signal by one or more of the same conductors of the transmission line.

2. The communication device of claim 1, wherein:
the second circuit is configured to send the outbound radio-frequency communication signal and the control signal via the one or more of the same conductors of the transmission line concurrently; and
the second circuit is configured to produce the control signal with at least one frequency, with each of the at least one frequency being different from a frequency of any other part of the control signal and different from a frequency of the outbound radio-frequency communication signal.

3. The communication device of claim 2, wherein the amplifier is a power amplifier and the first circuit further comprises a low-noise amplifier, the first circuit being configured to respond to a first value of the control signal by enabling the low-noise amplifier, and to respond to a second value of the control signal by enabling the power amplifier.

4. The communication device of claim 3, wherein the first circuit is configured to respond to the second value of the control signal by setting an operational mode of the power amplifier.

5. The communication device of claim 1, wherein:
the first circuit is further configured to send the second portion of the amplified radio-frequency communication signal over the transmission line as the feedback signal; and
the second circuit and the first circuit are configured, respectively, to send the outbound radio-frequency communication signal and the feedback signal via the one or more of the same conductors of the transmission line concurrently.

6. The communication device of claim 5, wherein the first circuit is configured to frequency modulate the second portion of the amplified radio-frequency communication signal to produce the feedback signal such that a frequency of the feedback signal is different from a frequency of the outbound radio-frequency communication signal.

7. The communication device of claim 6, wherein the first circuit is configured to frequency modulate the second portion of the amplified radio-frequency communication signal by mixing the second portion of the amplified radio-frequency communication signal with the control signal.

8. The communication device of claim 1, wherein the first circuit is configured to produce and send the feedback signal over the transmission line and the second circuit is configured to use the feedback signal to adjust a setting affecting linearity of the amplifier.

9. The communication device of claim 1, wherein the first circuit comprises an active antenna including the amplifier and the antenna element, and the second circuit comprises a signal processor.

10. The communication device of claim 9, wherein:
the active antenna further includes a low-noise amplifier communicatively coupled to the antenna element and configured to amplify an inbound communication signal received by the antenna element; and
the amplifier is a power amplifier communicatively coupled to the antenna element and configured to transmit the first portion of the outbound radio-frequency communication signal to the antenna element.

11. The communication device of claim 1, wherein the amplifier is a power amplifier and the second circuit comprises a transceiver.

12. A communication method comprising:
producing an outbound radio-frequency communication signal in a second circuit of a communication device;
sending the outbound radio-frequency communication signal from the second circuit to an amplifier of a first circuit of the communication device via a transmission line that comprises a plurality of conductors;
amplifying the outbound radio-frequency communication signal in the amplifier to produce an amplified signal;
sending a first portion of the amplified signal to an antenna element of the communication device; and
producing and sending a control signal to the first circuit via the transmission line; or
sending, based on a second portion of the amplified signal, a feedback signal to the second circuit via the transmission line; or
a combination thereof;
such that the control signal or the feedback signal, or a combination thereof, is concurrently conveyed with the outbound radio-frequency communication signal by one or more of the same conductors of the transmission line.

13. The method of claim 12, wherein:
the outbound radio-frequency communication signal and the control signal are sent such that the outbound radio-frequency communication signal and the control signal are conveyed by the one or more of the same conductors of the transmission line concurrently; and
producing the control signal comprises producing the control signal with at least one frequency, with each of the at least one frequency being different from a frequency of any other part of the control signal and different from a frequency of the outbound radio-frequency communication signal.

14. The method of claim 13, further comprising:
in response to a first value of the control signal, enabling a low-noise amplifier of the first circuit; and
in response to a second value of the control signal, enabling a power amplifier of the first circuit.

15. The method of claim 14, further comprising, in response to the second value of the control signal, setting an operational mode of the power amplifier.

16. The method of claim 12, wherein the outbound radio-frequency communication signal and the feedback signal are sent such that the outbound radio-frequency communication signal and the feedback signal are conveyed by the one or more of the same conductors of the transmission line concurrently, the method further comprising frequency modulating the second portion of the amplified signal to produce the feedback signal such that a frequency of the feedback signal is different from a frequency of the outbound radio-frequency communication signal.

17. The method of claim 16, wherein frequency modulating the second portion of the amplified signal comprises mixing the second portion of the amplified signal with the control signal.

18. The method of claim 16, further comprising providing digital pre-distortion using the feedback signal to produce the outbound radio-frequency communication signal to help linearize an output of the amplifier.

19. A communication device comprising:
at least one transmission line;
first means, communicatively coupled to the at least one transmission line, for:
receiving an outbound radio-frequency communication signal and a control signal;
amplifying the outbound radio-frequency communication signal to produce an amplified signal;
sending a first portion of the amplified signal to an antenna element; and
sending, based on a second portion of the amplified signal, a feedback signal to the at least one transmission line; and
second means, communicatively coupled to the at least one transmission line, for producing and sending the outbound radio-frequency communication signal and the control signal to the at least one transmission line and for receiving the feedback signal from the at least one transmission line;
wherein the first means and the second means are for, respectively, sending and receiving, via the at least one transmission line, the outbound radio-frequency communication signal and the control signal or the feedback signal, or a combination thereof, concurrently over one or more of the same conductors of a single transmission line of the at least one transmission line.

20. The communication device of claim 19, wherein:
the second means are for sending the outbound radio-frequency communication signal and the control signal via the same conductors of the single transmission line concurrently; and
the second means are for producing the control signal with at least one frequency, with each of the at least one frequency being different from a frequency of any other part of the control signal and different from a frequency of the outbound radio-frequency communication signal.

21. The communication device of claim 20, wherein the first means include a low-noise amplifier and a power amplifier, and the first means are for responding to a first value of the control signal by enabling the low-noise amplifier, and for responding to a second value of the control signal by enabling the power amplifier.

22. The communication device of claim 21, wherein the first means are for responding to the second value of the control signal by setting an operational mode of the power amplifier.

23. The communication device of claim 19, wherein:
the second means and the first means are for, respectively, sending the outbound radio-frequency communication signal and the feedback signal via the one or more of the same conductors of the single transmission line concurrently; and
the first means are for frequency modulating the second portion of the amplified signal to produce the feedback signal such that a frequency of the feedback signal is different from a frequency of the outbound radio-frequency communication signal.

24. The communication device of claim 23, wherein the first means are for frequency modulating the second portion of the amplified signal by mixing the second portion of the amplified signal with the control signal.

25. The communication device of claim 23, wherein the second means are for producing the outbound radio-frequency communication signal using the feedback signal to provide digital pre-distortion.

26. A power amplifier system comprising:
an input coupled to a transmission line comprising a plurality of conductors;
an output coupled to an antenna element;
amplifying means for amplifying a radio frequency signal received over the transmission line; and
control means for controlling the amplifying means based on a control signal received over one or more of the same conductors of the transmission line concurrently with the radio frequency signal.

27. The power amplifier system of claim 26, further comprising means for transmitting a feedback signal over the one or more of the same conductors of the transmission line.
